(19) United States
(12) Patent Application Publication
(10) Pub. No.: US 2022/0235239 A1
(43) Pub. Date: Jul. 28, 2022

(54) THERMOPLASTIC GEL COAT

(71) Applicants: ARKEMA INC., King Of Prussia, PA (US); GLIMA INNOVATION LTDA, Sao José dos Pinhais, Parana (BR)

(72) Inventors: Gilmar DA COSTA LIMA, Curitiba Parana (BR); Robert J. BARSOTTI, Newtown Square, PA (US); Dana L. SWAN, Spring City, PA (US)

(73) Assignees: ARKEMA INC., King Of Prussia, PA (US); GLIMA INNOVATION LTDA, Sao José dos Pinhais, Parana (BR)

(21) Appl. No.: 17/616,412

(22) PCT Filed: Jun. 3, 2020
(86) PCT No.: PCT/US2020/035997

§ 371 Date: Dec. 3, 2021

Related U.S. Application Data
(60) Provisional application No. 62/856,846, filed on Jun. 4, 2019.

(51) Int. Cl. C09D 133/10; C09D 7/40; B29C 37/00

(52) U.S. Cl. CPC C09D 133/10; B29C 37/0025; C09D 7/40

(57) ABSTRACT

ABTRACT

The present invention relates to a liquid, thermoplastic acrylic gel cap composition that can impart UV resistance, higher impact, and aesthetic effects to a composite material. Additionally, the post processing of the material when combined with a thermoplastic composite can allow for thermoformability, weldability and recyclability, unlike seen with traditional thermoset based gel coats.

### FIELD OF THE INVENTION

The present invention relates to a liquid, thermoplastic acrylic gel cap composition that can impart UV resistance, higher impact, and aesthetic effects to a composite material. Additionally, the post processing of the material when combined with a thermoplastic composite can allow for thermoformability, weldability and recyclability, unlike seen with traditional thermoset based gel coats.

### BACKGROUND OF THE INVENTION

Gel coats are widely used as the external surface layer of composite molded articles, and especially on articles exposed to the environment. The gel coating provides a strong, flexible, UV resistant, abrasion resistance, impact resistant, moisture resistant surface. It also provides a high-quality, smooth, glossy finish, with good color. Additionally, the gel coat can provide mold release properties. Examples of articles benefiting from a gel coat are boat hulls, bath tubs and bathtub enclosures, pool, spas, body panels of cars and trucks, ad wind blades.

Gel coats are typically applied as a liquid onto the inside of a mold by spraying, brushing or another means, followed by the application of composite fibers and resin onto the gel coat. The gel coat may be cured prior to the application of the composite material, or by curing the composite and gel coat together, then removing the cured gel coated composite article from the mold.

Gel coats compositions are typically cured thermosetting polymers based on epoxy, vinyl ester, or unsaturated polyester resin chemistry. U.S. Pat. No. 6,211,259 describes the use of a thermoset gel coating on a polyurethane or polyurethane foam.

Liquid acrylic syrup for the production of thermoplastic composite articles, has been developed by Arkema, as described in, for example, U.S. Pat. No. 9,777,140 and U.S. Pat. No. 10,294,358, incorporated herein by reference. The liquid syrup contains an acrylic polymer dissolved in acrylic monomer, in the presence of an initiator. Reinforcing fibers are impregnated with the liquid acrylic syrup, followed by polymerization, to produce a tough, thermoplastic composite material.

Problem:

The current gel cap compositions are thermoset polymer materials. Thermoset polymers have at least two major disadvantages. A thermoset polymer matrix is rigid, and cannot easily be shaped into other forms. Once the polymer has been cured the form is fixed. Thermoset polymer articles are also difficult to recycle and are either burned for their fuel value, or thrown into a waste dump.

Solution:

A liquid thermoplastic (meth)acrylic gelcoat has been developed as an alternative to thermoset gel coats. The thermoplastic acrylic gelcoat provides the excellent aesthetics for which acrylic polymers are known, as well as providing a tough, UV resistance, high impact, exterior layer. The gel cap of the invention is recyclable, weldable and thermoformable,

### SUMMARY OF THE INVENTION

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In a first aspect, a (meth)acrylic, thermoplastic gel coat layer having as a matrix polymer the polymerization reaction product of a (meth)acrylic syrup comprising at least one (meth)acrylic polymer dissolved in at least one (meth)acrylic monomer and at least one initiator or initiator system, and wherein said (meth)acrylic syrup has a dynamic viscosity at 25° C. of between 10 mPa*s and 10,000 mPa*s, preferably between 50 mPa*s and 5000 mPa*s and advantageously between 100 mPa*s and 1000 mPa*s.

In a second aspect, the (meth)acrylic thermoplastic gel coat of aspect 1, contains at least one (meth)acrylic polymer that is a (meth)acrylic copolymer having at least 70 percent by weight of methyl methacrylate monomer units and from 0.3 to 30% by weight of at least one monomer having at least one ethylenic unsaturation that can copolymerize with methyl methacrylate.

In a third aspect, the (meth)acrylic thermoplastic gel coat of any of aspects 1 or 2, contains at least one (meth)acrylic polymer selected from the group consisting of a mixture of at least one homopolymer and at least one copolymer of MMA, a mixture of at least two homopolymers or two copolymers of MMA having different weight average molecular weights, and mixture of at least two copolymers of MMA with a different monomer composition.

In a fourth aspect, the (meth)acrylic thermoplastic gel coat of any or the previous aspects is formed from a (meth)acrylic syrup that further contains from 0.1 to 40 weight percent, based on the (meth)acrylic syrup of at least one material selected from the group consisting of inorganic compounds, nanosilica, graphene, impact modifiers, graphite nanoparticles, carbon nanotubes, acrylic compatible pigments and dyes, UV absorbers, matting agents, cross-linked acrylic beads, aldehydes, and citral aldehyde.

In a fifth aspect, the (meth)acrylic thermoplastic gel coat of any of the previous aspects, further contains a thin fiber veil or mat.

In a sixth aspect. the (meth)acrylic thermoplastic gel coat of any of the previous aspects, involves an initiator selected from the group consisting of UV activated initiators, diacyl peroxides, peroxy esters, dialkyl peroxides, peroxyacetals, benzoyl peroxide, and peroxy dicarbonates.

In a seventh aspect, in the (meth)acrylic thermoplastic gel coat of aspect 6, the initiator is present at from 100 to 50,000 ppm by weight based on the total (meth)acrylic monomer.

In an eighth aspect, the (meth)acrylic thermoplastic gel coat of any of the previous aspects has the (meth)acrylic monomer(s) of the liquid syrup present at 50 percent or greater by weight.

In a ninth aspect, a multi-layer composite material contains

a) a fiber-reinforced substrate layer, and

b) a gel cap layer, where the gel coat layer described in any of the previous aspects.

In a tenth aspect, the multi-layer composite material of aspect 9,contains a fiber- reinforced substrate layer comprises a thermoplastic matrix polymer.

In an eleventh aspect, the multi-layer composite material of any of aspects 9 or 10, contains a fiber-reinforced thermoplastic substrate layer containing a (meth)acrylic matrix and a fibrous material, wherein said fibrous material comprises either a fiber with an aspect ratio of the fiber of at least 1000 or the fibrous material has a two dimensional macroscopic structure.

In a twelfth aspect, a process for forming a fiber-reinforced composite is described, having a top gel coat layer exposed to the environment, comprising

a. forming a liquid thermoplastic syrup comprising at least one (meth)acrylic polymer dissolved in at least one (meth)acrylic monomer and at least one initiator or initiator system, wherein said (meth)acrylic syrup has a dynamic viscosity at 25°0 C. of between 10 mPa*s and 10,000 mPa*s;

b. applying said liquid thermoplastic syrup to the inside surface of a mold;

c. at least partially polymerizing said liquid thermoplastic syrup;

d. applying a mixture of composite fibers and substrate matrix resin precursor onto the gelcoat;

e. curing said matrix resin precursor in the presence of said fibers, and in contact with said gel coat; and

c. removing the gel-coated, fibre-reinforced composite from the mold.

In a thirteenth aspect, a process for repairing, coating, re-coating, or improving the surface of composite material is described, comprising the steps of

a. forming a liquid thermoplastic syrup comprising at least one (meth)acrylic polymer dissolved in at least one (meth)acrylic monomer and at least one initiator or initiator system, wherein said (meth)acrylic syrup has a dynamic viscosity at 25° C. of between 10 mPa*s and 10,000 mPa*s;

b. applying a thin layer of said liquid thermoplastic syrup onto a fiber-reinforced article, said cured layer thickness being from 100 to 100 micrometers thick, and preferably from 300—500 micrometers in thickness;

c. curing said liquid thermoplastic syrup layer; and

d. optionally surface treating said gel coat by a process selected from the group consisting of polishing, buffing, wiping, chemical treating, and sanding.

In a fourteenth aspect, a gel-coated composite article, having the multi-layer composite material of aspect 10,where said article is selected from the group consisting of boat hulls, bath tubs and bathtub enclosures, pool, spas, body panels of cars and trucks, ad wind blades.

### DETAILED DESCRIPTION OF THE INVENTION

“Copolymer” as used herein, means a polymer having two or more different monomer units. “Polymer” is used to mean both homopolymer and copolymers. For example, as used herein, “PMMA” and “polymethyl methacrylate” are used to connote both the homopolymer and copolymers, unless specifically noted otherwise. “Acrylic” and “(meth)acrylate” is used to connote both acrylates and methacrylates, as well as mixtures of these. Polymers may be straight chain, branched, star, comb, block, or any other structure. The polymers may be homogeneous, heterogeneous, and may have a gradient distribution of co-monomer units. All references cited are incorporated herein by reference.

As used herein, unless otherwise described, percent shall mean weight percent. Molecular weight is a weight average molecular weight as measured by GPC. In cases where the polymer contains some cross-linking, and GPC cannot be applied due to an insoluble polymer fraction, soluble fraction/gel fraction or soluble fraction molecular weight after extraction from gel is used.

By the term “PMMA” as used herein denotes homo- and copolymers of methylmethacrylate (MMA), for the copolymer of MMA the weight ratio of MMA inside the PMMA is at least 70 wt%.

By the term “monomer” as used herein denotes a molecule which can undergo polymerization.

By the term “polymerization” as used herein denotes a process of converting a monomer or a mixture of monomers into a polymer.

By the term “thermoplastic polymer” as used herein denotes a polymer that turns to a liquid or becomes more liquid or less viscous when heated and that can take on new shapes by the application of heat and pressure.

By the term “thermosetting polymer” as used herein denotes a prepolymer in a soft, solid or viscous state that changes irreversibly into an infusible, insoluble polymer network by curing.

By the term “polymer composite” as used herein denotes a multicomponent material comprising multiple different phase domains in which at least one type of phase domain is a continuous phase and in which at least one component is a polymer.

By the term “initiator” as used herein denotes a chemical species that's reacts with a monomer to form an intermediate compound capable of linking successively with a large number of other monomers into a polymeric compound.

Liquid gel coat composition

The liquid thermoplastic (meth)acrylic resin of the invention, also called a liquid (meth)acrylic syrup, is a viscous, polymerizable blend of (meth)acrylic polymer(s), (meth)acrylic monomer(s), and initiator.

(Meth)acrylic polymer: The (meth)acrylic polymer of the invention is a poly alkyl methacrylate or polyalkyl acrylate. In a preferred embodiment the (meth)acrylic polymer is poly methyl methacrylate (PMMA).

In one embodiment the (meth)acrylic polymer comprises at least 70%, by weight of methyl methacrylate monomer units.

In another embodiment the PMMA is a mixture of at least one homopolymer and at least one copolymer of MMA, or a mixture of at least two homopolymers or two copolymers of MMA with a different average molecular weight or a mixture of at least two copolymers of MMA with a different monomer composition.

The copolymer of methyl methacrylate (MMA) comprises from 70% to 99.7% by weight, preferably from 80% to 99.7% advantageously from 90% to 99.7% and more advantageously from 90% to 99.5% by weight of methyl methacrylate and from 0.1% to 30%, preferably from 0.3% to 20% advantageously from 0.3% to 10% and more advantageously from 0.5% to 10% by weight of methyl methacrylate and from 0.3 to 30% by weight of at least one monomer having at least one ethylenic unsaturation that can copolymerize with methyl methacrylate. These monomers are well known and mention may be made, in particular of acrylic and methacrylic acids and alkyl- (meth)acrylates in which the alkyl group has from 1 to 12 carbon atoms. As examples, mention may be made of methyl acrylate and ethyl, butyl or 2-ethylhexyl (meth)acrylate. Preferably the comonomer is an alkyl acrylate in which the alkyl group has from 1 to 4 carbon atoms, and most preferably methyl acrylate or ethyl acrylate or mixtures thereof.

The weight average molecular weight of the (meth)acrylic polymer should be high, meaning larger than 50,000g/mol, preferably larger than 100,000g/mol.

The weight average molecular weight can be measured by size exclusion chromatography (SEC).

(Meth)acrylic monomer: The (meth)acrylic polymer is dissolved in one or more (meth)acrylic monomers. The monomer(s) are chosen from acrylic acid, methacrylic acid, alkyl acrylic monomers, alkyl methacrylic monomers and mixtures thereof.

Preferably the monomer is chosen from acrylic acid, methacrylic acid, alkyl acrylic monomers, alkyl methacrylic monomers and mixtures thereof, the alkyl group having from 1 to 22 carbons, either linear, branched or cyclic; preferably the alkyl group having from 1 to 12 carbons, either linear, branched or cyclic.

Advantageously the (meth)acrylic monomer is chosen from methyl methacrylate, ethyl methacrylate, methyl acrylate, ethyl acrylate, methacrylic acid, acrylic acid, n-butyl acrylate, iso- butyl acrylate, n- butyl methacrylate, iso-butyl methacrylate, cyclohexyl acrylate, cyclohexyl methacrylate, isobornyl acrylate, isobornyl methacrylate and mixtures thereof.

More advantageously the monomer is chosen (meth)acrylic monomer is chosen from methyl methacrylate, isobornyl acrylate or acrylic acid and mixtures thereof.

In a preferred embodiment at least 50 wt%, and more preferably at least 70 wt%, of the monomer is methyl methacrylate.

In a more preferred embodiment at least 50 wt%, of the monomer is a mixture of methyl methacrylate with isobornyl acrylate and/or acrylic acid.

The (meth)acrylic monomer or the (meth)acrylic monomers in the liquid (meth)acrylic syrup are present at from at least 40% by weight, preferably 50% by weight, advantageously 60% by weight and more advantageously 65% by weight of total liquid (meth) acrylic syrup based on the total (meth)acrylic monomer and (meth)acrylic polymer.

The (meth)acrylic monomer or the (meth)acrylic monomers in the liquid (meth)acrylic syrup are present at less than 90% by weight. The (meth)acrylic polymer or polymers in the liquid (meth)acrylic syrup are present at from 10% by weight to 60% by weight.

The (meth)acrylic polymer or polymers in the liquid (meth) acrylic syrup are present at from 60% to 10% by weight, preferably from 50% to 10% by weight, of the total liquid syrup based on the total of (meth)acrylic monomer and (meth)acrylic polymer.

The dynamic viscosity of the liquid (meth) acrylic syrup is in a range from 10 mPa*s to 10,000 mPa*s, preferably from 50 mPa*s to 5,000 mPa*s and advantageously from 100 mPa*s to 1,000 mPa*s. The viscosity of the syrup can be easily measured with a Rheometer or viscometer. The dynamic viscosity is measured at 25° C. The liquid (meth) acrylic syrup has a Newtonian behaviour, meaning no shear thinning, so that the dynamic viscosity is independent of the shearing in a rheometer or the speed of the mobile in a viscometer.

Initiator: The initiator or initiating system for starting the polymerization of the (meth)acrylic monomer, includes initiators or initiating systems that are activated by heat.

The heat activated initiator is preferably a radical initiator. The radical initiator can be chosen from diacyl peroxides, peroxy esters, dialkyl peroxides, peroxyacetals or azo compounds.

Preferably the initiator or initiating system for starting the polymerization of the (meth) acrylic monomer is chosen from peroxides having 2 to 20 carbon atoms.

The content of radical initiator with respect to the (meth)acrylic monomer of a liquid (meth)acrylic syrup is from 100 to 50,000 ppm by weight, preferably between 200 and 40,000 ppm by weight and advantageously between 300 and 30000 ppm.

In one embodiment, the initiator or initiating system is selected from isopropyl carbonate, benzoyl peroxide, lauroyl peroxide, caproyl peroxide, dicumyl peroxide, tert-butyl perbenzoate, tert-butyl per(2-ethylhexanoate), cumyl hydroperoxide, 1,1-di(tert-butylperoxy)-3 ,3 ,5 -trimethyl- cyclohexane, tert-butyl peroxyisobutyrate, tert-butyl peracetate, tert-butyl perpivalate, amyl perpival ate, tert-butyl peroctoate, azobisisobutyronitrile (AIBN), azobisisobutyramide, 2,2′ -azo- bis(2,4-dimethylvaleronitrile) or 4,4′ -azobis(4-cyanopentanoic). It would not be departing from the scope of the invention to use a mixture of radical initiators.

Preferably the initiator or initiating system for starting the polymerization of the (meth) acrylic monomer is chosen from peroxides having 2 to 20 carbon atoms

In one embodiment an inhibitor is present to prevent the monomer from spontaneously polymerising.

ADDITIVES

The liquid (meth)acrylic syrup of the invention may optionally contain, and preferably does contain, one or more additives, in order to improve the cost, hardness, scratch & mar resistance and aesthetics of the gel coat. The content of additives in the liquid (meth) acrylic syrup is from 0 to 40 wt%, preferably from 2 to 20 wt %, and more preferably from 3 to 15 wt%. These include, but are not limited to inorganic compounds; nanoparticles, such as nanosilica, graphene, graphite nanoparticles, carbon nanotubes; acrylic compatible pigments and dyes, UV absorbers, matting agents, impact modifiers, cross-linked acrylic beads, surface tension additive, defoamers, aldehydes, and citral aldehyde.

A lower viscosity (meth)acrylic monomer and (meth)acrylic polymer syrup could be used when higher levels of additives are being incorporated, so the overall viscosity of the syrup remains in the useful dynamic viscosity range of between 10 mPa*s and 10,000 mPa*s at 25° C. methylmethacrylate monomer could be added to the syrup to adjust the viscosity to the desired level.

In one embodiment nanosilica is added to improve scratch/mar resistance;

In one embodiment, one or more impact modifiers are added to improve impact resistance. The impact modifier is in the form of fine particles having an elastomer core and at least one thermoplastic shell, the size of the particles being in general less than 1 μm and advantageously between 50 and 300 nm. The impact modifier is prepared by emulsion polymerization. The impact modifier content in the (meth)acrylic syrup is between 0 and 40%, preferably between 0 and 20%, and advantageously between 0 and 10% by weight. Typical impact modifiers cause an increase the viscosity of (meth)acrylic syrup, and thus must be used at lower level. Special nano-sized impact modifiers, such as NANOSTRENGTH® block copolymer from Arkema which is not made by an emulsion process, may be used at higher levels, with less of an increase in the viscosity.

In another embodiment, graphene or GRAPHISTRENGTH® resin from Arkema, is added to improve impact resistance.

In another embodiment acrylic compatible pigments and dyes are added to provide for colored weatherable top surfaces. The proper selection of pigments and mold design could produce a high gloss/Class A surface, which is especially useful for auto or other aesthetic applications.

Another embodiment of the invention includes the incorporation of UV absorbers into the gel coat, to provide UV resistance.

Matting agents are added, in another embodiment, to reduce gloss or even provide a textured surface. Useful matting agents include cross-linked acrylic beads, inorganic additives such as silicone beads.

In another embodiment, one or more flame retardants are added to the liquid syrup that produces the gel coat, providing flame retardancy to the gel coated article.

In another embodiment, aldehydes, such as citral aldehyde are added to decrease air sensitivity of the cure.

An activator may be added, to work with the initiator to commence polymerization. The content of the activator with respect to the to the (meth)acrylic monomer of the liquid (meth) acrylic syrup is from 100 ppm to 10,000 ppm (by weight), preferably from 200 ppm to 7000 ppm by weight and advantageously from 300 ppm to 4000 ppm.

In another embodiment, a thin fiber veil or mat may be added into the gel coat layer, in order to increase the strength of the gel coat. By a thin veil or mat is meant a single fiber ply material is meant, generally in the range of from 50 to 250 micrometers thick, and preferably from 75 to 200 micrometers thick.

In another embodiment, one or more surface tension additives are added to the liquid syrup that produces the gel coat, reducing surface tension in order to provide gel coat wetting and developing a smooth and homogeneous gel coat film.

In another embodiment, one or more defoamers are added to the liquid syrup that produces the gel coat, preventing foam and bubbles formation during gel coat manufacturing and application.

PROCESS

The gel coat liquid resin is produced by blending together the (meth)acrylic polymer(s), (meth) acrylic monomer(s), initiator, and any additives. The gel coat syrup may be applied by means known in the art, such as spraying, and brushing. The (meth)acrylic thermoplastic gel coat layer then provides a surface gel coat layer, once cured. The gel coat layer is typically from 100 to 1000 micrometers thick, and preferably from 300 to 500 micrometers in thickness.

The curing rate of the gel coat can be controlled, as known in the art, such as increasing the rate by using a promoter, such as, for example, an amine, a Fe/saccharin system, or other metal promoters, or the rate can be retarded using an inhibitor.

In one embodiment, the gel coat liquid syrup is applied to the inside surface of a mold. The gel coat is at least partially cured in place. Fibers and a resin are then added to the mold against the gel coat and activated to produce a composite substrate having an exterior gel coat.

In one embodiment, the gel coat is not entirely cured when the fiber/resin mixture is added. This allows the gel coat to intermingle with the uncured composite resin at the surface, providing a strong bond once the gel coat and resin are fully cured.

In another embodiment, the gel coat is added to a finished composite article, for example by hand lamination of a gel layer to the composite.

The gel coat liquid could also be used to repair composite materials, by applying the liquid syrup to the surface of the composite, followed by curing of the gel coat by heat, or radiation.

The gel coat of the invention provides excellent adhesion when added to the surface of a thermoplastic composite, such as ELIUM® resin from Arkema, and heat applied-allowing the polymer chains at the surface to intermingle. An all-thermoplastic composite/gel coat system has an added advantage, in that the entire article is recyclable.

In another embodiment, a blend of aldehydes and peroxide (MEKP) and metallic salts, preferably Co and Cu salts are added to the syrup for promoting the polymerization.

In still another rembodiment, a hand lamination/repair resin containing MEKP initiator, a saccharine promoter and citral aldehyde is used to inhibit oxygen, for application ease, and painting.

PROPERTIES

The thermoplastic gel coat of the invention has several notable properties, which make it extremely useful for many articles.

One large advantage over thermoset gel coats, is that the thermoplastic gel coat is recyclable at the end of life. It is the only product which can combine with thermoplastic resin in order to produce a reinforced composite part that is 100% thermoplastic, thermoformable and recyclable.

The (meth) acrylic gel coat provides better UV stability and better aesthetics -high gloss, sharper colors (something like more jet black) than current thermoset gel coat. It further provides the ability to alter the surface finish of the gel coat. For example, the (meth) acrylic gel coat allows for incorporation of organic or inorganic matting agents, creating a low or medium gloss finish. Larger size matting agents may be used for a textured matte surface. The gel coat of the invention also has high hardness and better impact performance than current gel coats.

The (meth) acrylic gel coat of the invention bonds well to many common thermoset and thermoplastic materials, making it useful in most applications.

Additionally, the thermoplastic gel coat of the invention, allows one to post-process gel- coated material in ways that are not possible with a thermoset gel coat. The coating is thermoformable and it can be welded to other thermoplastic materials.

Some specific benefits of the gel coat of the invention include the following:
The gelcoat of the invention is the only product which can combine with thermoplastic resin to produce a reinforced composite part that is 100% thermoplastic, thermoformable and recyclable. This is especially useful in swimming pools, boats, construction panels and truck refrigeration boxes.
the gel coat of the invention provides superior elongation strength, eliminating the need of flexible resin blends and/or plasticizing aditives. This is especially useful in composite sheet coils for general panels and buses front panels.
the gel coat of the invention eliminates steps in RTM and RTM-TS processes, as there is no need of extrusion in either thermoforming processes. An RTM-S process combines three diferente steps (extrusion, thermoforming with thermoset injection (RTM))- targeting a Class “A” finishing, while an RTM-TS process combines three different steps (extrusion and thermoforming with Thermoset injection with thermoplastic resin) targeting a Class A surface and possible recycling. This property is especially useful in co-extruded ABS/PMMA fiberglass or carbono fiber reinforced Jacuzzis.
the gel coat of the invention provides an excellent surface gloss finish, reducing readthrough from fiberglass, aramide or carbono fiber used as reinforcement in composites. This property is useful in, for example, FRP boats, water slides and FRP toilet parts.
the gel coat of the invention provides a high UV and hydrolisis resistance, which is especially useful in FRP boats, jet skis, water slides, etc.
higher impact and fatigue resistance, which is especially useful in application such as windblades and general wind energy components.
provides fire resistance properties (intumescente characteristic), which is useful, for example, in train Sseats, covering parts, toilets, etc.
provides a CLASS A surface for composite parts, especially useful for example in car parts, such as hoods side panels and other body parts.

USES

Because of its versatility and advantageous properties, the gel coating of the invention is useful in many end-use applications, including but not limited to marine transport- including over fiberglass boat hulls, land transport- such a s trucks, cars, trains, off-road vehicles, lawn and garden equipment.

Other uses for the gel coat of the invention include, but are not limited to: swimming pools, boats, construction panels and truck refrigeration boxes, composites sheets coils for general panels and buses front panels, co-extruded ABS/PMMA fiberglass or carbono fiber reinforced

Jacuzzis, FRP boats, water slides, FRP toilet parts, windblades, general wind energy componentes, train seats, covering parts, toilets, and car body parts.

A thermoplastic composite substrate, coated with the thermoplastic gel coat of the invention, can be thermoformed into final articles. This is not possible with thermoset substrates, or thermoset gel coats.

RECYCLING

On large advantage of the thermoplastic gel coat of the invention, is that when the thermoplastic gel coat is to coat a thermoplastic composite material, the entire structure, as well as any scrap during the manufacturing process, can be recycled.

Recycling of the thermoplastic composite material or manufactured mechanical or structured part or article comprising the thermoplastic composite material it can be made by grinding or depolymerization of the thermoplastic polymer.

Grinding is done mechanically in order to obtain smaller parts or pieces and a thermoplastic gel coat. As the structured part compromises thermoplastic polymer and a thermoplastic gel coat, the ground pieces can be heated, and the pieces transformed by typical thermoforming processes into a recycled object.

Alternately, the structured part comprising the thermoplastic composite and thermoplastic gel coat is heated for making a pyrolysis or thermal decomposition of the PMMA and recovering the methyl methacrylate (MMA) as monomer. Advantageously at least 50 wt% of the MMA present in the polymer are recovered by thermal decomposition.

### EXAMPLES:

Example 1: (all percentages are weight percents)

A sample White Gelcoat formulation:

In a reactor with a paddle stirrer, 82.5 wt% of ELIUM® 150 liquid resin system is blended with an additive package consisting of a filler, calcium carbonate 5%, pigment titanium oxide 10%, fumed silica at 1.5% and leveling and antifoaming agents at 0.5% each. After blending, the formulation has a room temperature viscosity in the range of 300 to 1000 cPs.

Example 2

An unpigmented gel coat formulation:

In a reactor with a paddle stirrer, 75% Elium® 150 resin is blended with an additive package consisting of 15% of a filler such as calcium carbonate or aluminum trihydrate, 1.5% rheological modifiers such as Crayvallac® LA150 or fumed silica and leveling and antifoaming agents (such as BYK W 9010 and BYK A515). After mixing until uniformly blended, a room temperature viscosity in the range of 300 to 1000cPs is achieved.

Example 3

Application of Gelcoat

The gel coat formulation from example 1 is blended with 1.0 to 1.5% of a catalyst such as Luperox® A75, benzoyl peroxide. The blended mixture is then applied to the female side of a prepared mold by spray coating or hand layup with rollers. The gelcoat should be applied to generate a thickness of about 20-25 mils. The tack time for the resin will be approximately 20 minutes at 25° C., and full cure achieved in under 1 hour. After the tack time is achieved, the laminate stack for the main composite can be laid up (fibers including glass and carbon, core components including foam, etc). The entire set-up in then vacuum bagged and then a thermoplastic resin such as the Elium® family of liquid resins can be introduced via vacuum infusion. After cure, the entire part is thermoplastic and therefore can be post processed with standard thermoplastic post-processing methodologies including thermoforming, welding, and recycling.

What is claimed is:

1. A (meth)acrylic, thermoplastic gel coat layer comprising the polymerization reaction product of a (meth)acrylic syrup comprising at least one (meth)acrylic polymer dissolved in at least one (meth)acrylic monomer and at least one initiator or initiator system, and wherein said (meth)acrylic syrup has a dynamic viscosity at 25° C. of between 10 mPa*s and 10,000 mPa*s, preferably between 50 mPa*s and 5000 mPa*s and advantageously between 100 mPa*s and 1000 mPa*s.

2. The (meth)acrylic thermoplastic gel coat of claim 1, wherein at least one (meth)acrylic polymer comprises a (meth)acrylic copolymer comprising at least 70 percent by weight of methyl methacrylate monomer units and from 0.3 to 30% by weight of at least one monomer having at least one ethylenic unsaturation that can copolymerize with methyl methacrylate.

3. The (meth)acrylic thermoplastic gel coat of claim 1, wherein said at least one (meth)acrylic polymer is selected from the group consisting of a mixture of at least one homopolymer and at least one copolymer of MMA, a mixture of at least two homopolymers or two copolymers of MMA having different weight average molecular weights, and mixture of at least two copolymers of MMA with a different monomer composition.

4. The (meth)acrylic thermoplastic gel coat of claim 1, wherein said (meth)acrylic syrup further comprises from 0.1 to 40 weight percent, based on the (meth)acrylic syrup of at least one material selected from the group consisting of inorganic compounds, nanosilica, graphene, impact modifiers, graphite nanoparticles, carbon nanotubes, acrylic compatible pigments and dyes, UV absorbers, matting agents, cross-linked acrylic beads, aldehydes, and citral aldehyde.

5. The (meth)acrylic thermoplastic gel coat of claim 1, wherein said gel coat layer further comprises a thin fiber veil or mat.

6. The (meth)acrylic thermoplastic gel coat of claim 1, wherein said initiator is selected from the group consisting of UV activated initiators, diacyl peroxides, peroxy esters, dialkyl peroxides, peroxyacetals, benzoyl peroxide, and peroxy dicarbonates.

7. The (meth)acrylic thermoplastic gel coat of claim 1, wherein said initiator is present at from 100 to 50,000 ppm by weight based on the total (meth)acrylic monomer.

8. The (meth)acrylic thermoplastic gel coat of claim 1, wherein (meth)acrylic monomer(s) of the liquid syrup are present at 50 percent or greater by weight.

9. A multi-layer composite material comprising:
a) a fiber-reinforced substrate layer, and
b) a gel cap layer, comprising the gel cap of claim 1.

10. The multi-layer composite material of claim 9, wherein said fiber-reinforced substrate layer comprises a thermoplastic matrix polymer.

11. The multi-layer composite material of claim 10, wherein said fiber-reinforced thermoplastic substrate layer comprises a (meth)acrylic matrix and a fibrous material, wherein said fibrous material comprises either a fiber with an aspect ratio of the fiber of at least 1000 or the fibrous material has a two dimensional macroscopic structure.

12. A gel-coated composite article, comprising the multi-layer composite material of claim 10, wherein said article is selected from the group consisting of boat hulls, bath tubs and bathtub enclosures, pool, spas, body panels of cars and trucks, and wind blades. swimming pools, construction panels and truck refrigeration boxes, composites sheets coils for general panels and buses front panels, co-extruded ABS/PMMA fiberglass or carbono fiber reinforced Jacuzzis, water slides, FRP toilet parts, general wind energy componentes, train seats, covering parts, toilets, and car body parts.

13. A process for forming a fiber-reinforced composite having a top gel coat layer exposed to the environment, comprising
a. forming a liquid thermoplastic syrup comprising at least one (meth)acrylic polymer dissolved in at least one (meth)acrylic monomer and at least one initiator or initiator system, wherein said (meth)acrylic syrup has a dynamic viscosity at 25° C. of between 10 mPa*s and 10,000 mPa*s;
b. applying said liquid thermoplastic syrup to the inside surface of a mold;
c. at least partially polymerizing said liquid thermoplastic syrup;
d. applying a mixture of composite fibers and substrate matrix resin precursor onto the gelcoat;
e. curing said matrix resin precursor in the presence of said fibers, and in contact with said gel coat; and
c. removing the gel-coated, fibre-reinforced composite from the mold.

14. A process for repairing, coating, re-coating, or improving the surface of composite material comprising the steps of
a. forming a liquid thermoplastic syrup comprising at least one (meth)acrylic polymer dissolved in at least one (meth)acrylic monomer and at least one initiator or initiator system, wherein said (meth)acrylic syrup has a dynamic viscosity at 25° C. of between 10 mPa*s and 10,000 mPa*s;
b. applying a thin layer of said liquid thermoplastic syrup onto a fiber-reinforced article, said cured layer thickness being from 100 to 1000 micrometers thick, and preferably from 300- 500 micrometers in thickness;
c. curing said liquid thermoplastic syrup layer; and
d. optionally surface treating said gel coat by a process selected from the group consisting of polishing, buffing, wiping, chemical treating, and sanding.

15. An article comprising recycled thermoplastic composite material and thermoplastic gel coat, wherein said thermoplastic polymeric composite material comprises
(a) a polymeric thermoplastic (meth)acrylic matrix
(b) a fibrous material as reinforcement wherein the fibrous material comprises either a fiber with an aspect ratio of the fiber of at least 1000 or the fibrous material has a two dimensional macroscopic structure and wherein the gel coat comprises the thermoplastic gel coat layer of claim 1.

16. The article of claim 13, wherein said fibers are unsized fibers recovered from the thermoplastic composite material by pyrolysis.
